(19) United States
(12) Patent Application Publication
(10) Pub. No.: US 2021/0096624 A1
(43) Pub. Date: Apr. 1, 2021

(54) ELECTRONIC APPARATUS AND OPERATION INFORMATION OUTPUT METHOD

(71) Applicant: LENOVO (SINGAPORE) PTE. LTD., SINGAPORE (SG)

(72) Inventors: Chikara Takahashi, YOKOHAMA (JP); Hideshi Tsukamoto, YOKOHAMA (JP)

(73) Assignee: LENOVO (SINGAPORE) PTE. LTD., SINGAPORE (SG)

(21) Appl. No.: 16/746,788

(22) Filed: Jan. 17, 2020

(30) Foreign Application Priority Data
Sep. 30, 2019 (JP) 2019178297

(51) Int. Cl. G06F 1/26; G06F 13/20; G06F 13/42

(52) U.S. Cl. CPC G06F 1/266; G06F 2213/0042; G06F 13/4282; G06F 13/20

(57) ABSTRACT

An electronic apparatus includes: a main control unit configured to execute a process based on an operating system; an interface control unit configured to control an interface for communicating with an outside; and a rewritable non-volatile storage unit configured to store setting information of the interface and operation information which is information relating to operation of the operating system, wherein the interface control unit is configured to cause the non-volatile storage unit to store the operation information acquired, and, in response to an output request from the outside, output the operation information stored in the non-volatile storage unit by the interface.

### FIELD OF THE INVENTION

The present invention relates to an electronic apparatus and an operation information output method.

### BACKGROUND OF THE INVENTION

Techniques of recording operation information such as operation time in electronic apparatuses such as personal computers are known (for example, Japanese Unexamined Patent Application Publications No. 2005-269019, No. 2007-173885, and No. 2008-131458). With such conventional techniques, operation information is stored in a hard disk drive (HDD), a solid state drive (SSD), or the like included in an electronic apparatus or stored in an external apparatus via a network by execution of a program on an operating system (OS).

### SUMMARY OF THE INVENTION

With the foregoing conventional techniques, however, the operation information may be unable to be output in the case where, for example, the 0S cannot be started or the electronic apparatus cannot be connected to the network. Thus, with the conventional techniques, the operation information may be unable to be output depending on the operating environment.

The present invention has been made to solve the problem stated above, and has an object of providing an electronic apparatus and an operation information output method that can appropriately output operation information while reducing operating environment dependency.

To solve the problem stated above, an aspect of the present invention is an electronic apparatus including: a main control unit configured to execute a process based on an operating system; an interface control unit configured to control an interface for communicating with an environment outside of the electronic apparatus; and a rewritable non-volatile storage unit configured to store setting information of the interface and operation information which is information relating to operation of the operating system, wherein the interface control unit is configured to cause the non-volatile storage unit to store the operation information acquired, and, in response to an output request from the outside environment, output the operation information stored in the non-volatile storage unit by the interface.

In the electronic apparatus according to an aspect of the present invention, the operation information may include an operation time of the operating system, and the interface control unit may be configured to acquire system state transition information and transition date and time of the operating system, generate the operation time based on the acquired system state transition information and transition date and time, and cause the non-volatile storage unit to store the generated operation time as the operation information.

In the electronic apparatus according to an aspect of the present invention, the interface control unit may be configured to acquire system state transition information and transition date and time of the operating system, generate an operation time of the operating system based on the acquired system state transition information and transition date and time, and output the generated operation time by the interface as the operation information.

In the electronic apparatus according to an aspect of the present invention, the operation information may include operation history information associating the system state transition information and the transition date and time with each other, and the interface control unit may be configured to cause the non-volatile storage unit to store the operation history information as the operation information.

In the electronic apparatus according to an aspect of the present invention, the operation information may include a start count of the operating system, and the interface control unit may be configured to generate the start count based on the system state transition information and the transition date and time, and cause the non-volatile storage unit to store the generated start count as the operation information.

In the electronic apparatus according to an aspect of the present invention, the operation information may include temperature information in the electronic apparatus or power-good information indicating a power state in the electronic apparatus, and the interface control unit may be configured to acquire the temperature information or the power-good information, and cause the non-volatile storage unit to store the acquired temperature information or power-good information as the operation information.

In the electronic apparatus according to an aspect of the present invention, the interface may be Universal Serial Bus (USB) Type-C, and the interface control unit may be configured to output the operation information to the outside, using a Vendor Defined Message (VDM) function by CC signal of USB Type-C.

In the electronic apparatus according to an aspect of the present invention, the interface control unit may be a power delivery (PD) controller of USB Type-C.

The electronic apparatus according to an aspect of the present invention may include a sub control unit configured to operate independently of the main control unit, and manage a peripheral, and the sub control unit may be configured to acquire the operation information, and transmit the acquired operation information to the interface control unit to cause the non-volatile storage unit to store the operation information.

An aspect of the present invention is an operation information output method in an electronic apparatus that includes: a main control unit configured to execute a process based on an operating system; an interface control unit configured to control an interface for communicating with an outside; and a rewritable non-volatile storage unit configured to store setting information of the interface and operation information which is information relating to operation of the operating system, the operation information output method including: a storage step in which the interface control unit causes the non-volatile storage unit to store the operation information acquired; and an output step in which the interface control unit, in response to an output request from the outside, outputs the operation information stored in the non-volatile storage unit by the interface.

The above-described aspects of the present invention can appropriately output operation information while reducing operating environment dependency.

### BRIEF DESCRIPTION OF THE DRAWINGS

FIG. 1 is a diagram illustrating an example of a main hardware structure of a laptop PC according to a first embodiment.

FIG. 2 is a block diagram illustrating an example of a functional structure of the laptop PC according to the first embodiment.

FIG. 3 is a diagram illustrating an example of data in an operation history storage unit in the first embodiment.

FIG. 4 is a flowchart illustrating an example of operation of an embedded controller in the first embodiment.

FIG. 5 is a flowchart illustrating an example of an operation information recording process of a PD controller in the first embodiment.

FIG. 6 is a flowchart illustrating an example of an operation information output process of the PD controller in the first embodiment.

FIG. 7 is a block diagram illustrating an example of a functional structure of a laptop PC according to a second embodiment.

FIG. 8 is a flowchart illustrating an example of an operation information recording process of a PD controller in the second embodiment.

FIG. 9 is a flowchart illustrating an example of an operation information output process of the PD controller in the second embodiment.

### DETAILED DESCRIPTION OF THE INVENTION

An electronic apparatus and an operation information output method according to each embodiment of the present invention will be described below, with reference to drawings.

### First Embodiment

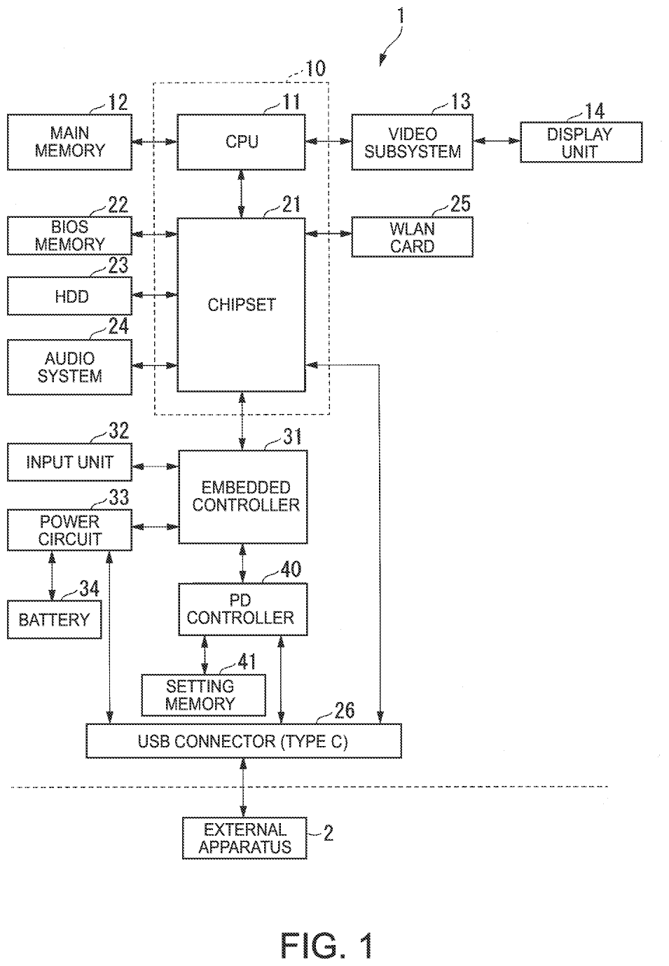

FIG. 1 is a diagram illustrating an example of a main hardware structure of a laptop PC 1 according to a first embodiment. In this embodiment, the laptop PC 1 is described as an example of an electronic apparatus.

The laptop PC 1 includes a CPU 11, a main memory 12, a video subsystem 13, a display unit 14, a chipset 21, a BIOS memory 22, a HDD 23, an audio system 24, a WLAN card 25, a USB connector 26, an embedded controller 31, an input unit 32, a power circuit 33, a battery 34, a PD controller 40, and a setting memory 41, as illustrated in FIG. 1.

In this embodiment, the CPU 11 and the chipset 21 correspond to a main control unit 10.

The CPU (central processing unit) 11 performs various arithmetic processing by program control, and controls the overall laptop PC 1.

The main memory 12 is a writable memory used as an area for reading execution programs of the CPU 11 or a work area for writing processed data of the execution programs. For example, the main memory 12 is made up of a plurality of dynamic random access memory (DRAM) chips. The execution programs include an OS (operating system), various drivers for hardware-operating peripherals, various services/utilities, and application programs.

The video subsystem 13 is a subsystem for implementing a function relating to image display, and includes a video controller. The video controller processes a rendering instruction from the CPU 11, and writes the processed rendering information to a video memory. The video controller also reads the rendering information from the video memory, and outputs it to the display unit 14 as rendering data (display data).

The display unit 14 is, for example, a liquid crystal display, and displays a display screen based on the rendering data (display data) output from the video subsystem 13.

The chipset 21 includes controllers such as USB (Universal Serial Bus), Serial ATA (AT Attachment), SPI (Serial Peripheral Interface) bus, PCI (Peripheral Component Interconnect) bus, PCI-Express bus, and eSPI (Embedded Serial Peripheral Interface) bus (or LPC (Low Pin Count) bus), and is connected to a plurality of devices. In FIG. 1, devices such as the BIOS memory 22, the HDD 23, the audio system 24, the WLAN card 25, and the USB connector 26 are connected to the chipset 21.

The BIOS (Basic Input/Output System) memory 22 is, for example, composed of an electrically rewritable non-volatile memory such as electrically erasable programmable read only memory (EEPROM) or flash ROM. The BIOS memory 22 stores the BIOS, system firmware for controlling the embedded controller 31, etc., and the like.

The HDD (Hard Disk Drive) 23 stores an OS, various drivers, various services/utilities, application programs, and various data.

The audio system 24 records, reproduces, and outputs sound data.

The WLAN (Wireless Local Area Network) card 25 connects to a network via a wireless LAN, to perform data communication. For example, upon receiving data from the network, the WLAN card 25 generates an event trigger indicating the reception of the data.

The USB connector 26 is a connector for connecting peripherals using USB. For example, the USB connector 26 is a USB Type-C connector, and is used for various data communication and power supply using USB Type-C. The USB connector 26 will be described in detail later.

The embedded controller (EC) 31 (an example of a sub control unit) is a one-chip microcomputer that monitors and controls each device (peripherals, sensors, etc.) regardless of the system state of the laptop PC 1. The embedded controller 31 also has a power management function of controlling the power circuit 33. The embedded controller 31 is composed of a CPU, a ROM, a RAM, and the like (not illustrated), and includes A/D input terminals, D/A output terminals, timers, and digital input and output terminals of a plurality of channels. The embedded controller 31 is connected to the input unit 32, the power circuit 33, and the like via these input and output terminals, and controls their operations.

The embedded controller 31 controls the power circuit 33 depending on the system state (e.g. S0 state to S5 state) defined in the ACPI (Advanced Configuration and Power Interface) specifications. S0 state is the most active state, and is a typical operation state (normal operation state). S5 state is a shut-down state (power off state) in which power is turned off by software.

The CPU 11 in this embodiment corresponds to S0ix state which is a low power state from which the system can promptly return to S0 state. The embedded controller 31 executes control of the power circuit 33 corresponding to standby mode (e.g. modern standby mode) using this S0ix state. Herein, S0ix state is an extended state of S0 state defined in the ACPI specifications, and is reduced in power consumption as compared with S0 state.

The input unit 32 is an input device such as a keyboard, a pointing device, and a touchpad.

The power circuit 33 includes, for example, a DC/DC converter, a charge/discharge unit, and the like, and converts a DC voltage supplied from the AC/DC adapter or the battery 34 into a plurality of voltages necessary to operate the laptop PC 1. The power circuit 33 supplies power to each unit in the laptop PC 1, based on control by the embedded controller 31. The power circuit 33 also outputs power-good information indicating the output state of power supply of each power voltage, to the embedded controller 31.

The battery 34 is, for example, a lithium ion battery, and supplies DC power to each unit in the laptop PC 1 via the power circuit 33. For example, the battery 34 is charged with DC power supplied from the power circuit 33, based on DC power supplied from an AC/DC adapter (charger) connected to the laptop PC 1 via the USB connector 26.

The PD (power delivery) controller 40 (an example of an interface control unit) controls a USB Type-C interface for communicating with the outside environment (e.g. the external apparatus 2). In the case where the AC/DC adapter is connected as the external apparatus 2, the PD controller 40 performs negotiation with the AC/DC adapter on the power supplied from the AC/DC adapter, based on setting information stored in the below-described setting memory 41. The PD controller 40 will be described in detail later.

The setting memory 41 (an example of a non-volatile storage unit) stores various setting information negotiated with the external apparatus 2 in USB Type-C, and operation information (e.g. operation history information, operation time) of the laptop PC 1. The setting memory 41 is, for example, an electrically rewritable non-volatile memory such as EEPROM, and is connected to the PD controller 40 by an SPI interface. The setting memory 41 will be described in detail later.

The external apparatus 2 is an apparatus connected to the USB connector 26 and supporting USB Type-C. Examples of the external apparatus 2 include an AC/DC adapter, an external storage apparatus, and an external display apparatus. When outputting the below-described operation information to the outside, the external apparatus 2 is a maintenance apparatus.

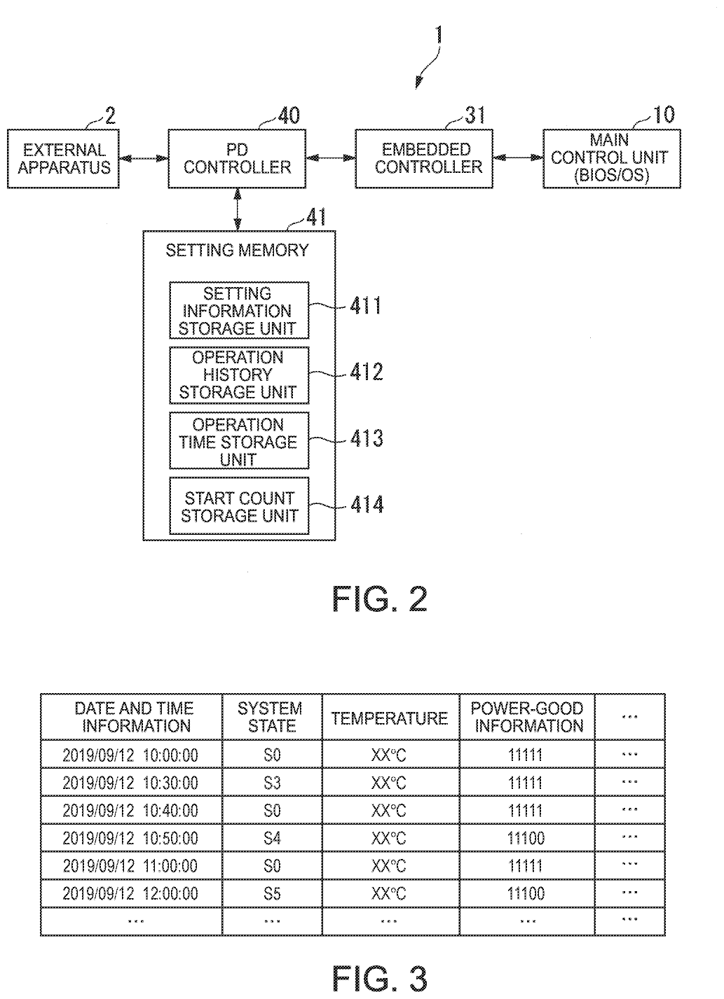

A functional structure of the laptop PC 1 according to this embodiment will be described below, with reference to FIG. 2.

FIG. 2 is a block diagram illustrating an example of the functional structure of the laptop PC 1 according to this embodiment.

The laptop PC 1 includes the main control unit 10, the embedded controller 31, the PD controller 40, and the setting memory 41, as illustrated in FIG. 2. The PD controller 40 in the laptop PC 1 is connectable to the external apparatus 2 (maintenance apparatus in this example). FIG. 2 illustrates only a main functional structure relating to the invention of this embodiment.

The main control unit 10 is a functional unit mainly implemented by the CPU 11 and the chipset 21, and executes processes based on the BIOS and the OS. The main control unit 10 executes various processes based on the OS (e.g. Windows®), applications, etc. The main control unit 10 controls transitions among system states defined in the ACPI specifications, such as SO state (normal operation state), S0ix state (modern standby mode), S3 state (sleep mode), S4 state (hibernation mode), and S5 state (shut-down).

The setting memory 41 stores various setting information of USB Type-C and operation information of the laptop PC 1. The operation information of the laptop PC 1 is information about the operation of the OS, and includes, for example, the operation time of the OS, the start count of the OS, temperature information in the laptop PC 1 (the electronic apparatus), the power state in laptop PC 1, and system state transition information and transition date and time of the OS.

The setting memory 41 includes a setting information storage unit 411, an operation history storage unit 412, an operation time storage unit 413, and a start count storage unit 414.

The setting information storage unit 411 stores the foregoing various setting information of USB Type-C.

The operation history storage unit 412 stores operation history information. For example, the operation history storage unit 412 stores, as the operation history information, date and time information, system state, temperature, and power-good information in association with each other, as illustrated in FIG. 3.

The date and time information is, for example, information indicating the date and time at which a transition (change) in the system state of the OS occurred, and corresponds to transition date and time. The system state includes, for example, the foregoing system states of the OS such as S0 state, S0ix state, S3 state, S4 state, and S5 state, and indicates the transitioned system state. The temperature indicates the temperature information in the laptop PC 1. The power-good information indicates the output state of power supply of each power voltage in the laptop PC 1. The power-good information is, for example, flag information indicating whether each output power voltage is a predetermined voltage or more. Flag information indicates that the corresponding power voltage is supplied (output), and flag information “0” indicates that the corresponding power voltage is not supplied (not output).

In the example in FIG. 3, operation history information indicates that, at date and time information “2019/09/12 10:00:00”, the OS transitioned to S0 state, with the corresponding temperature being “XX ° C.” and power-good information being “11111”. Moreover, operation history information indicates that, at date and time information “2019/09/12 10:30:00”, the OS transitioned from S0 state to S3 state, with the corresponding temperature being “XX ° C.” and power-good information being “11111”.

The operation history storage unit 412 stores operation history information of a predetermined number of times (e.g. 10 times).

The operation time storage unit 413 stores the operation time of the OS. The operation time is, for example, the cumulative operation time in S0 state.

The start count storage unit 414 stores the start count of the OS. The start count is, for example, the cumulative start count of the OS, and may be a value obtained by counting the number of times the OS transitioned to S0 state.

The embedded controller 31 is connected to the main control unit 10 by, for example, an LPC interface or an SPI interface. The embedded controller 31 operates independently of the main control unit 10, and manages peripherals such as the power circuit 33. The embedded controller 31 acquires operation information, and transmits the acquired operation information to the PD controller 40 to store the operation information in the setting memory 41.

For example, the embedded controller 31, in response to system state transition information (e.g. a request to enter S0 state, a request to change from S0 state to another state (S0ix state, S3 state, or the like)) from the main control unit 10, acquires a system state from the main control unit 10, and acquires temperature information and power-good information from peripherals such as the power circuit 33. The embedded controller 31 also acquires date and time information from the BIOS (main control unit 10). The embedded controller 31 transmits the acquired date and time information, system state, temperature information, and power-good information to the PD controller 40 as operation history information, to store the operation history information in the operation history storage unit 412 in the setting memory 41.

The PD controller 40 is connected to the embedded controller 31 by, for example, an I2C (I-squared-C) interface. The PD controller 40 acquires operation information from the embedded controller 31, and stores the acquired operation information in the setting memory 41. For example, the PD controller 40 acquires the foregoing operation history information from the embedded controller 31, and stores the acquired operation history information in the operation history storage unit 412 as the operation information as illustrated in FIG. 3.

The PD controller 40 also generates the operation time based on the acquired system state transition information and transition date and time. That is, the PD controller 40 calculates the cumulative operation time during which the system state is S0 state, based on the acquired system state transition information and transition date and time, the system state transition information and transition date and time stored in the operation history storage unit 412, and the last cumulative operation time stored in the operation time storage unit 413. The PD controller 40 stores the generated cumulative operation time in the operation time storage unit 413 as the operation time.

The PD controller 40 also generates the start count based on the acquired system state transition information and transition date and time. That is, the PD controller 40 calculates the cumulative start count which is the number of times the OS started (i.e. the system state transitioned to S0 state), based on the acquired system state transition information and transition date and time and the last cumulative start count stored in the start count storage unit 414. The PD controller 40 stores the generated cumulative start count in the start count storage unit 414 as the start count.

The PD controller 40 also outputs the operation information stored in the setting memory 41 by a USB Type-C interface, in response to an output request from the outside (external apparatus 2). The PD controller 40 is connected to a CC terminal of USB Type-C of the USB connector 26 by a signal line of CC signal, and outputs the operation information to the external apparatus 2 through CC signal. Here, the PD controller 40 outputs the operation information (e.g. operation time, start count, and operation history information) to the outside, using the VDM (Vendor Defined Message) function of CC signal of USB Type-C.

Operation of the laptop PC 1 according to this embodiment will be described below, with reference to drawings.

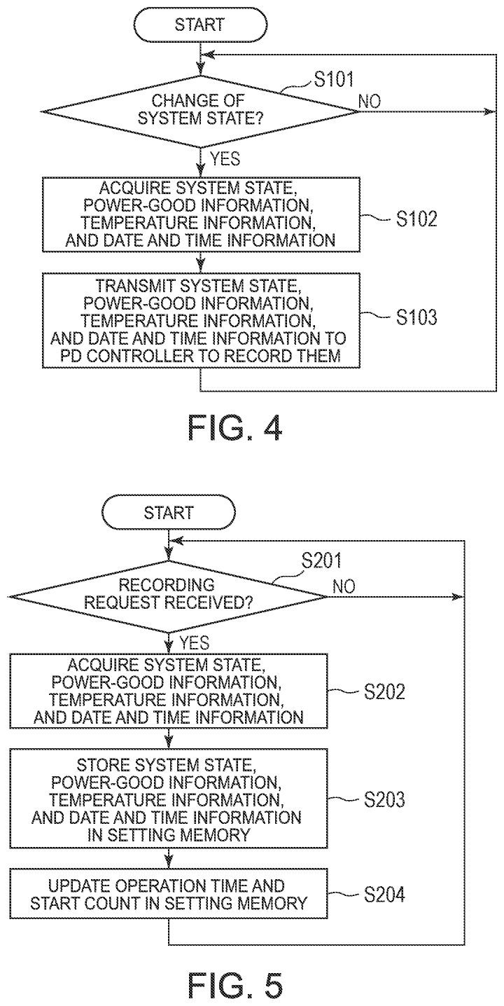

Operation of the embedded controller 31 in this embodiment will be described first, with reference to FIG. 4.

FIG. 4 is a flowchart illustrating an example of operation of the embedded controller 31 in this embodiment.

As illustrated in FIG. 4, the embedded controller 31 first determines whether there is a change in system state (step S101). The embedded controller 31 determines whether there is a system state change request (transition request) from the main control unit 10. In the case where there is a change in system state (step S101: YES), the embedded controller 31 advances the process to step S102. In the case where there is no change in system state (step S101: NO), the embedded controller 31 returns the process to step 5101.

In step S102, the embedded controller 31 acquires a system state, power-good information, temperature information, and date and time information. For example, the embedded controller 31 acquires the system state from the main control unit 10, and acquires the temperature information and the power-good information from peripherals such as the power circuit 33.

The embedded controller 31 then transmits the system state, the power-good information, the temperature information, and the date and time information to the PD controller 40 to record them (step S103). The embedded controller 31 transmits a recording request including the system state, the power-good information, the temperature information, and the date and time information to the PD controller 40 by the I2C interface, and causes the PD controller 40 to store the transmitted system state, power-good information, temperature information, and date and time information in the setting memory 41. After the process in step S103, the embedded controller 31 returns the process to step S101.

An operation information recording process of the PD controller 40 in this embodiment will be described next, with reference to FIG. 5.

FIG. 5 is a flowchart illustrating an example of the operation information recording process of the PD controller 40 in this embodiment.

As illustrated in FIG. 5, the PD controller 40 first determines whether a recording request is received (step S201). The PD controller 40 determines whether the foregoing recording request is received from the embedded controller 31. In the case where the recording request is received (step 5201: YES), the PD controller 40 advances the process to step 5202. In the case where the recording request is not received (step S201: NO), the PD controller 40 returns the process to step S201.

In step S202, the PD controller 40 acquires a system state, power-good information, temperature information, and date and time information. For example, the PD controller 40 acquires the system state, the power-good information, the temperature information, and the date and time information included in the recording request.

The PD controller 40 then stores the system state, the power-good information, the temperature information, and the date and time information in the setting memory 41 (step S203). That is, as illustrated in FIG. 3, the PD controller 40 stores the system state, the power-good information, the temperature information, and the date and time information received from the embedded controller 31, in the operation history storage unit 412 in the setting memory 41 in association with each other.

The PD controller 40 then updates the operation time and the start count in the setting memory 41 (step S204). The PD controller 40 calculates the cumulative operation time during which the system state is S0 state, based on the system state and date and time information received from the embedded controller 31, the system state and date and time information stored in the operation history storage unit 412, and the last cumulative operation time stored in the operation time storage unit 413. The PD controller 40 stores the generated cumulative operation time in the operation time storage unit 413 as the operation time. In the case where the received system state is irrelevant to the operation time, the PD controller 40 does not execute the operation time update process.

The PD controller 40 also calculates the cumulative start count which is the number of times the OS started (i.e. the system state transitioned to S0 state), based on the system state transition information and transition date and time acquired from the embedded controller 31 and the last cumulative start count stored in the start count storage unit 414. The PD controller 40 stores the generated cumulative start count in the start count storage unit 414 as the start count. In the case where the received system state is irrelevant to the start count, the PD controller 40 does not execute the start count update process.

After the process in step S204, the PD controller 40 returns the process to step S201.

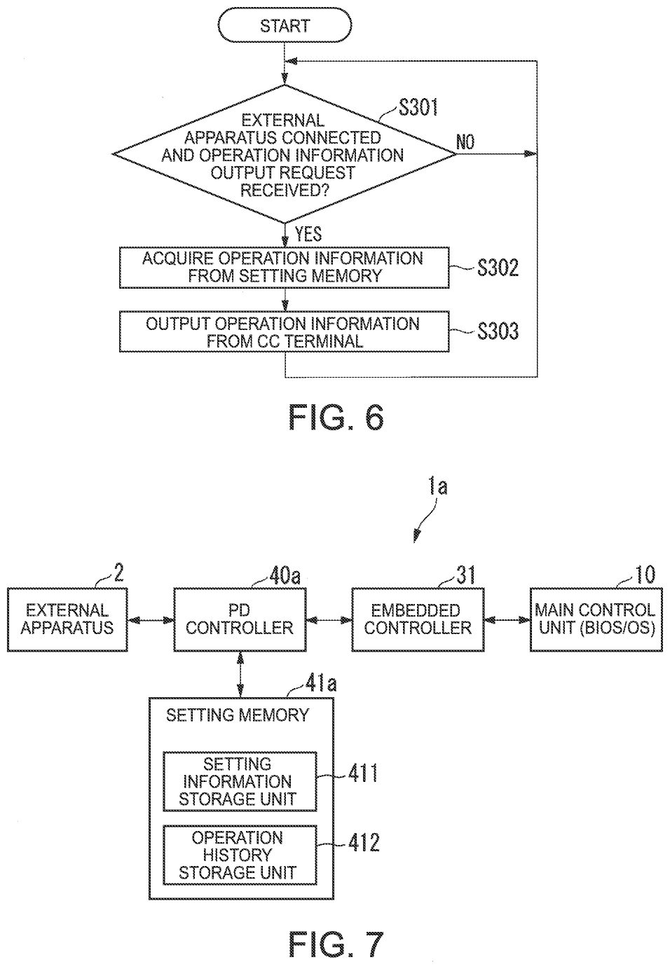

An operation information output process of the PD controller 40 in this embodiment will be described next, with reference to FIG. 6.

FIG. 6 is a flowchart illustrating an example of the operation information output process of the PD controller 40 in this embodiment.

As illustrated in FIG. 6, the PD controller 40 determines whether the external apparatus 2 is connected and an operation information output request is received (step S301). The PD controller 40 determines whether the external apparatus 2 is connected to the USB connector 26 and an operation information output request is received using the VDM function by CC signal. In the case where the external apparatus 2 is connected and an operation information output request is received (step S301: YES), the PD controller 40 advances the process to step S302. In the case where the external apparatus 2 is not connected or an operation information output request is not received (step S301: NO), the PD controller 40 returns the process to step S301.

In step S302, the PD controller 40 acquires the operation information from the setting memory 41. That is, the PD controller 40 acquires the operation time from the operation time storage unit 413 in the setting memory 41, and the start count from the start count storage unit 414 in the setting memory 41. The PD controller 40 also acquires the latest operation history information of the predetermined number of times from the operation history storage unit 412 in the setting memory 41.

The PD controller 40 then outputs the operation information from the CC terminal (step S303). The PD controller 40 outputs the operation time, start count, and latest operation history information of the predetermined number of times acquired from the setting memory 41, to the external apparatus 2 using the VDM function by CC signal. After the process in step 5303, the PD controller 40 returns the process to step S301.

As described above, the laptop PC 1 (electronic apparatus) according to this embodiment includes the main control unit 10, the PD controller 40 (interface control unit), and the setting memory 41 (non-volatile storage unit). The main control unit 10 executes a process based on an OS. The PD controller 40 controls an interface (e.g. USB Type-C) for communicating with the outside. The setting memory is a rewritable storage unit that stores setting information of the interface and operation information which is information relating to operation of the OS. The PD controller 40 stores acquired operation information in the setting memory 41, and, in response to an output request from the outside, outputs the operation information stored in the setting memory 41 by the interface.

Thus, in the laptop PC 1 according to this embodiment, the PD controller 40 that operates independently of the main control unit 10 acquires operation information from the setting memory 41 and outputs it to the outside. Therefore, for example even in a state in which the main control unit 10 is stopped or the main control unit 10 cannot be started, operation information can be recorded and output to the outside. Moreover, in the laptop PC 1 according to this embodiment, the setting memory 41 stores operation information. Hence, when storing operation information, for example, the laptop PC 1 need not be connected to the network. The laptop PC 1 according to this embodiment can thus appropriately output operation information while reducing operating environment dependency.

In the laptop PC 1 according to this embodiment, the PD controller 40 records operation information (stores operation information in the setting memory 41). Hence, the risk of alteration of operation information can be reduced as compared with, for example, the case where the main control unit 10 records operation information in the HDD 23. In addition, the laptop PC 1 according to this embodiment can appropriately record operation information, for example even in the case where the HDD 23 is replaced.

In this embodiment, the operation information includes the operation time of the OS. The PD controller 40 acquires system state transition information and transition date and time of the OS (e.g. the foregoing system state and date and time information), generates the operation time based on the acquired system state transition information and transition date and time, and stores the generated operation time in the setting memory 41 as the operation information.

Thus, for example, the laptop PC 1 according to this embodiment can manage the operation time of the laptop PC 1, which can be used for research on the relationship between the operation time and faults, lease contract in which the usage charge is changed depending on the operation time, increase/decrease of equipment of the laptop PC 1 depending on the operation time, etc.

In this embodiment, the operation information includes operation history information associating the system state transition information and the transition date and time with each other. The PD controller 40 stores the operation history information in the setting memory 41 as the operation information.

Thus, the laptop PC 1 according to this embodiment can record the operation history information and output it to the outside. This enables, for example, analysis on causes of faults of the laptop PC 1 and analysis on detailed operation of the laptop PC 1.

In this embodiment, the operation information includes the start count of the OS. The PD controller 40 generates the start count of the OS based on the system state transition information and transition date and time (e.g. the foregoing system state and date and time information), and stores the generated start count of the OS in the setting memory 41 as the operation information.

Thus, the laptop PC 1 according to this embodiment can record the start count of the OS and output it to the outside as the operation information. This enables more detailed operation state management and fault cause analysis.

In this embodiment, the operation information includes temperature information in the electronic apparatus (the laptop PC 1) or power-good information indicating the power state in the electronic apparatus. The PD controller 40 acquires the temperature information or the power-good information, and stores the acquired temperature information or power-good information in the setting memory 41 as the operation information.

Thus, the laptop PC 1 according to this embodiment can record the temperature information or the power-good information and output it to the outside as the operation information. This enables more detailed operation state management and fault cause analysis.

In this embodiment, the interface by which the PD controller 40 communicates with the outside is USB Type-C. The PD controller 40 outputs the operation information to the outside, using the VDM function by CC signal of USB Type-C.

Thus, the laptop PC 1 according to this embodiment outputs the operation information to the outside using the VDM function that can be uniquely determined by the vendor of the laptop PC 1. This enhances the confidentiality of the operation information. That is, with the laptop PC 1 according to this embodiment, the vendor of the laptop PC 1 can safely collect the operation information of the laptop PC 1 without being noticed by a third party.

In this embodiment, an interface control unit that controls the interface for communicating with the outside is the PD controller 40 of USB Type-C.

Thus, the laptop PC 1 according to this embodiment can output the operation information to the outside as long as it is in a state in which USB Type-C operates (a state in which the PD controller 40 operates), even when the main control unit 10 and the embedded controller 31 are not in operation. Moreover, since the laptop PC 1 according to this embodiment uses the existing PD controller 40 in the laptop PC 1, the operation information can be appropriately output with no need for additional parts and the like.

In this embodiment, the laptop PC 1 includes the embedded controller 31 (sub control unit) that operates independently of the main control unit 10 and manages a peripheral. The embedded controller 31 acquires the operation information, and transmits the acquired operation information to the PD controller 40 to store the operation information in the setting memory 41.

Thus, the laptop PC 1 according to this embodiment can collect and record the operation information, independently and regardless of the process of the OS.

An output method according to this embodiment is an operation information output method in the laptop PC 1 (electronic apparatus) including the main control unit 10 that executes a process based on an OS, the PD controller 40 (interface control unit) that controls an interface for communicating with the outside, and the rewritable setting memory 41 (non-volatile storage unit) that stores setting information of the interface and operation information which is information relating to operation of the OS, and includes a storage step and an output step. In the storage step, the PD controller 40 stores acquired operation information in the setting memory 41. In the output step, the PD controller 40 outputs the operation information stored in the setting memory 41 by the interface, in response to an output request from the outside.

Thus, the output method according to this embodiment has the same advantageous effects as the foregoing laptop PC 1, and can appropriately output operation information while reducing operating environment dependency.

### Second Embodiment

A laptop PC la according to a second embodiment will be described below, with reference to drawings.

This embodiment describes a modification when outputting the operation time and the start count to the outside.

FIG. 7 is a block diagram illustrating an example of a functional structure of the laptop PC la according to this embodiment.

The main hardware structure of the laptop PC 1a according to this embodiment is the same as that of the laptop PC 1 according to the first embodiment illustrated in FIG. 1, and accordingly its description is omitted here.

The laptop PC 1a includes the main control unit 10, the embedded controller 31, a PD controller 40a, and a setting memory 41a, as illustrated in FIG. 7. The PD controller 40a in the laptop PC 1a is connectable to the external apparatus 2 (maintenance apparatus in this example). FIG. 7 illustrates only a main functional structure relating to the invention of this embodiment. In FIG. 7, components same as those in FIG. 2 are given the same symbols, and their description is omitted.

The setting memory 41a stores various setting information of USB Type-C and operation information of the laptop PC 1a. The setting memory 41a includes the setting information storage unit 411 and the operation history storage unit 412. This embodiment differs from the first embodiment in that the setting memory 41a does not include the operation time storage unit 413 and the start count storage unit 414.

The operation history storage unit 412 in this embodiment stores operation history information, as in the example in FIG. 3. As the operation history information, all information from the operation information recording start are stored.

The PD controller 40a, for example, acquires the foregoing operation history information from the embedded controller 31, and stores the acquired operation history information in the operation history storage unit 412 as the operation information as illustrated in FIG. 3.

Moreover, in response to an output request from the outside (external apparatus 2), the PD controller 40a generates the operation time and the start count based on the operation history information, and outputs the generated operation time and start count to the outside as the operation information.

In response to the output request, the PD controller 40a acquires the operation history information (system state transition information and transition date and time) stored in the operation history storage unit 412, and, based on the operation history information (system state transition information and transition date and time), calculates the cumulative operation time during which the system state is S0 state. The PD controller 40a calculates the cumulative start count which is the number of times the OS started (i.e. the system state transitioned to S0 state), based on the operation history information (system state transition information and transition date and time).

The PD controller 40a, for example, outputs the operation information including the cumulative operation time as the operation time and the cumulative start count as the start count to the outside, using the VDM (Vendor Defined Message) function by CC signal of USB Type-C. The PD controller 40a may output not only the operation time and the start count but also the operation history information to the outside as the operation information.

Thus, the PD controller 40a acquires the system state transition information and transition date and time of the laptop PC la, generates the operation time and the start count of the laptop PC la based on the acquired system state transition information and transition date and time, and outputs the generated operation time and start count as the operation information by the USB Type-C interface.

Operation of the laptop PC la according to this embodiment will be described below, with reference to drawings.

The operation of the embedded controller 31 in this embodiment is the same as that in FIG. 4, and accordingly its description is omitted here.

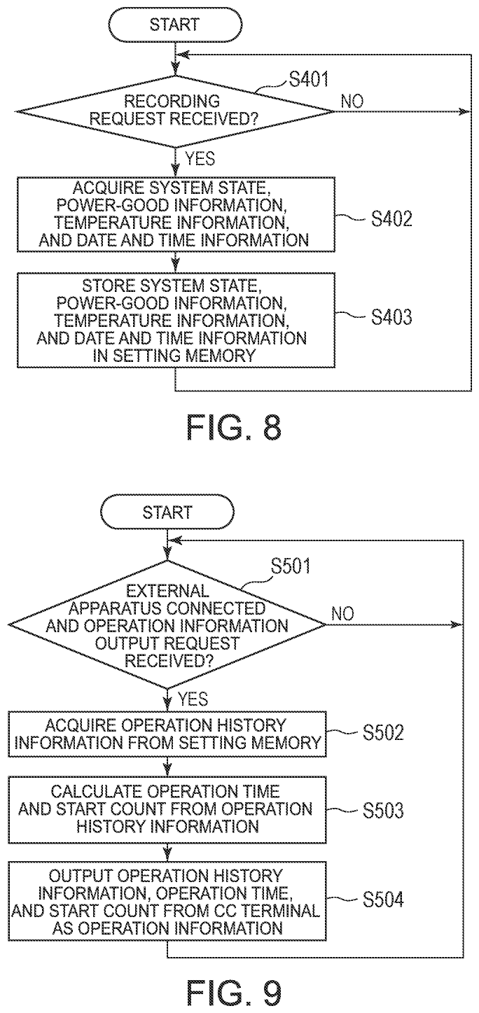

FIG. 8 is a flowchart illustrating an example of the operation information recording process of the PD controller 40a in this embodiment.

As illustrated in FIG. 8, the PD controller 40a first determines whether a recording request is received (step S401). In the case where the recording request is received (step S401: YES), the PD controller 40a advances the process to step S402. In the case where the recording request is not received (step S401: NO), the PD controller 40a returns the process to step S401.

In step S402, the PD controller 40a acquires a system state, power-good information, temperature information, and date and time information. For example, the PD controller 40a acquires the system state, the power-good information, the temperature information, and the date and time information included in the recording request.

The PD controller 40a then stores the system state, the power-good information, the temperature information, and the date and time information in the setting memory 41a (step S403). That is, as illustrated in FIG. 3, the PD controller 40a stores the system state, the power-good information, the temperature information, and the date and time information received from the embedded controller 31, in the operation history storage unit 412 in the setting memory 41a in association with each other. After the process in step S403, the PD controller 40a returns the process to step S401.

An operation information output process of the PD controller 40a in this embodiment will be described next, with reference to FIG. 9.

FIG. 9 is a flowchart illustrating an example of the operation information output process of the PD controller 40a in this embodiment.

As illustrated in FIG. 9, the PD controller 40a determines whether the external apparatus 2 is connected and an operation information output request is received (step S501). In the case where the external apparatus 2 is connected and an operation information output request is received (step S501: YES), the PD controller 40a advances the process to step S502. In the case where the external apparatus 2 is not connected or an operation information output request is not received (step S501: NO), the PD controller 40a returns the process to step S501.

In step S502, the PD controller 40a acquires the operation history information from the setting memory 41a. That is, the PD controller 40a acquires the operation history information of all times from the operation history storage unit 412 in the setting memory 41a.

The PD controller 40a then calculates the operation time and the start count from the operation history information (step S503). The PD controller 40a acquires the operation history information stored in the operation history storage unit 412, and, based on the operation history information, calculates the cumulative operation time during which the system state is S0 state, as the operation time. The PD controller 40a also calculates, based on the operation history information, the cumulative start count which is the number of times the OS started (i.e. the system state transitioned to S0 state), as the start count.

The PD controller 40a then outputs the operation history information, the operation time, and the start count from the CC terminal, as the operation information (step S504). The PD controller 40a outputs the operation history information, the operation time, and the start count to the external apparatus 2 as the operation information, using the VDM function by CC signal. After the process in step S504, the PD controller 40a returns the process to step S501.

As described above, in this embodiment, the PD controller 40a acquires system state transition information and transition date and time of the laptop PC 1a, generates the operation time and the start count of the laptop PC 1a based on the acquired system state transition information and transition date and time, and outputs the generated operation time by the interface as the operation information.

Thus, the laptop PC 1a according to this embodiment can manage the operation time of the laptop PC 1a as in the first embodiment, which can be used for research on the relationship between the operation time and the faults, lease contract in which the usage charge is changed depending on the operation time, increase/decrease of equipment of the laptop PC 1a depending on the operation time, etc.

The laptop PC 1a according to this embodiment can also output the start count of the OS to the outside as the operation information. This enables more detailed operation state management and fault cause analysis.

The present invention is not limited to the foregoing embodiments, and modifications can be made without departing from the scope of the present invention.

For example, although each of the foregoing embodiments describes an example in which the electronic apparatus is the laptop PC 1 (1a), the present invention is not limited to such. The electronic apparatus may be, for example, a tablet terminal apparatus, a desktop PC, or a smartphone.

Although each of the foregoing embodiments describes an example in which the laptop PC 1 (1a) includes the embedded controller 31, the present invention is not limited to such. For example, the laptop PC 1 (1a) may not include the embedded controller 31, like a smartphone.

The PD controller 40 (40a) may include all or part of the functions of the embedded controller 31, and the embedded controller 31 may include all or part of the functions of the PD controller 40 (40a).

Although each of the foregoing embodiments describes an example in which the PD controller 40 (40a) generates the cumulative time during which the system state is S0 state as the operation time, the present invention is not limited to such. The PD controller 40 (40a) may generate the cumulative time corresponding to each system state (e.g. S0 state, S0ix state, S3 state), as operation information.

Although each of the foregoing embodiments describes an example in which the PD controller 40 (40a) generates the number of transitions of the system state to S0 state as the start count, the present invention is not limited to such. The PD controller 40 (40a) may generate the number of transitions corresponding to each system state (e.g. S0 state, S0ix state, S3 state), as operation information.

Each component in the foregoing laptop PC 1 (1a) includes a computer system. Processes in the components in the foregoing laptop PC 1 (1a) may be performed by recoding a program for implementing the functions of the components in the foregoing laptop PC 1 (1a) on a computer-readable recording medium and causing a computer system to read and execute the program recorded on the recording medium. Herein, “causing the computer system to read and execute the program recorded on the recording medium” includes installing the program in the computer system. The “computer system” herein includes an OS and hardware such as peripheral devices.

The “computer system” may include a plurality of computer apparatuses connected via the Internet, a WAN, a LAN, or a network including a communication line such as a dedicated line. The “computer-readable recording medium” refers to a portable medium such as a flexible disk, a magneto-optical disc, a ROM, or a CD-ROM, or a storage device such as a hard disk embedded in the computer system. Thus, the recording medium storing the program may be a non-transitory recording medium such as a CD-ROM.

The recording medium includes a recording medium internally or externally provided to be accessible from a distribution server for distributing the program. A configuration in which the program is divided into a plurality of parts and the components in the laptop PC 1 (1a) combine the parts after the parts are downloaded at different timings may be adopted, and distribution servers for distributing the parts into which the program is divided may be different. The “computer-readable recording medium” includes a medium that holds the program for a certain period of time, such as a volatile memory (RAM) inside a computer system serving as a server or a client when the program is transmitted via a network. The program may be a program for implementing some of the above-described functions. The program may be a differential file (differential program) that can implement the above-described functions in combination with a program already recorded in the computer system.

Some or all of the above-described functions may be implemented as an integrated circuit such as large scale integration (LSI). The above-described functions may be individually formed as a processor, or some or all thereof may be integrated into a processor. A method of forming an integrated circuit is not limited to LSI, and may be implemented by a dedicated circuit or a general-purpose processor. In the case where integrated circuit technology that can replace LSI emerges as a result of the advancement of semiconductor technology, an integrated circuit based on such technology may be used.

1. An electronic apparatus comprising:
a main control unit that executes a process based on an operating system;
an interface control unit that controls an interface for communicating with an environment outside of the electronic apparatus; and
a rewritable non-volatile storage unit that stores setting information of the interface and operation information relating to operation of the operating system, wherein the interface control unit causes the non-volatile storage unit to store acquired operation information and, in response to an output request from the outside environment, output the operation information, which is stored in the non-volatile storage unit, by the interface.

2. The electronic apparatus according to claim 1, wherein the operation information includes an operation time of the operating system, and
wherein the interface control unit acquires system state transition information and transition date and time of the operating system, generates the operation time based on the acquired system state transition information and transition date and time, and causes the non-volatile storage unit to store the generated operation time as the operation information.

3. The electronic apparatus according to claim 1, wherein the interface control unit acquires system state transition information and transition date and time of the operating system, generates an operation time of the operating system based on the acquired system state transition information and transition date and time, and outputs, by the interface, the generated operation time as the operation information.

4. The electronic apparatus according to claim 2, wherein the operation information includes operation history information associating the system state transition information and the transition date and time, with each other, and
wherein the interface control unit causes the non-volatile storage unit to store the operation history information as the operation information.

5. The electronic apparatus according to claim 2, wherein the operation information includes a start count of the operating system, and
wherein the interface control unit generates the start count based on the system state transition information and the transition date and time, and causes the non-volatile storage unit to store the generated start count as the operation information.

6. The electronic apparatus according to claim 1, wherein the operation information includes at least one of temperature information in the electronic apparatus and power-good information indicating a power state in the electronic apparatus, and
wherein the interface control unit acquires the at least one of temperature information and the power-good information, and causes the non-volatile storage unit to store the acquired at least one of temperature information and power-good information as the operation information.

7. The electronic apparatus according to claim 1, wherein the interface is Universal Serial Bus (USB) Type-C, and
wherein the interface control unit outputs the operation information to the outside environment, using a Vendor Defined Message (VDM) function by CC signal of USB Type-C.

8. The electronic apparatus according to claim 7, wherein the interface control unit is a power delivery (PD) controller of USB Type-C.

9. The electronic apparatus according to claim 1, comprising
a sub control unit that operates independently of the main control unit, and manages a peripheral,
wherein the sub control unit acquires the operation information, and transmits the acquired operation information to the interface control unit to cause the non-volatile storage unit to store the operation information.

10. An operation information output method in an electronic apparatus that includes: a main control unit that executes a process based on an operating system; an interface control unit that controls an interface for communicating with an environment outside of the electronic apparatus; and a rewritable non-volatile storage unit that stores setting information of the interface and operation information which is information relating to operation of the operating system, the operation information output method comprising:
a step of acquiring the operation information through the interface control unit;
a step of storing the acquired operation information in the non-volatile storage unit; and
a step of, in response to an output request from the outside environment, outputting the operation information stored in the non-volatile storage unit by the interface.
